(19) United States
(12) Patent Application Publication
(10) Pub. No.: US 2007/0182693 A1
(43) Pub. Date: Aug. 9, 2007

(54) Data driver, flat panel display device using the same, and driving method thereof

(76) Inventors: Oh Kyong Kwon, Seoul (KR); Byong Deok Choi, Seoul (KR)

Correspondence Address: CHRISTIE, PARKER & HALE, LLP, PO BOX 7068, PASADENA, CA, 91109-7068, US

(21) Appl. No.: 11/700,348

(22) Filed: Jan. 30, 2007

(30) Foreign Application Priority Data
Feb. 9, 2006 (KR) 2006-0012560

(51) Int. Cl. G09G 3/36

(52) U.S. Cl. 345/100

(57) ABSTRACT

A data driver including: a shift register unit for providing sampling signals by generating at least one shift register clock; a sampling latch unit for sampling and latching digital data having m bits by receiving the sampling signals for every column line; a holding latch unit for simultaneously receiving and latching the digital data latched from the sampling latch unit, for outputting upper k bits including a most significant bit (MSB) of the digital data, and converting and outputting the remaining lower m-k bits of the digital data in a serial state, wherein k is less than m; and a digital-analog converter for presetting a range of gray scale voltages through the upper k bits of the digital data provided from the holding latch unit, for executing charge sharing to correspond to the remaining lower m-k bits, and for finally generating and outputting the gray scale voltages.

### CROSS-REFERENCE TO RELATED APPLICATION

This application claims priority to and the benefit of Korean Patent Application No. 10-2006-0012560, filed on Feb. 9, 2006, in the Korean Intellectual Property Office, the entire content of which is incorporated herein by reference.

### BACKGROUND

1. Field of the Invention

The present invention relates to a flat panel display device, and, more particularly, to a data driver provided on a flat panel display device and a driving method thereof.

2. Discussion of Related Art

A flat panel display device includes a display panel, a scan driver, and a data driver. The scan driver sequentially outputs scan driving signals to a plurality of scan lines formed on the display panel, and the data driver outputs R, G, B image signals to data lines on the display panel. Non-limiting examples of a flat panel display device include a liquid crystal display device, a field emission display device, a plasma display panel, a light emitting display device, etc.

FIG. 1 is a block diagram showing a conventional data driver.

Here, the data driver will be described on the assumption that it has n channels.

Referring to FIG. 1, the data driver includes: a shift register unit 110, a sampling latch unit 120, a holding latch unit 130, a digital-analog converter (DAC) 140, and an amplifier 150.

The shift register unit 110 receives a source shift clock (SSC) and a source start pulse (SSP) from a timing controller (not shown), and generates n sampling signals in sequence, while allowing the source start pulse (SSP) to be shifted for every one period of the source shift clock (SSC). To generate the n sampling signals, the shift register unit 110 includes n shift registers.

The sampling latch unit 120 sequentially stores data in response to the sampling signals supplied from the shift register 110 in sequence. Here, the sampling latch unit 120 is provided with n sampling latches for storing n digital data. Also, the respective sampling latches have sizes corresponding to the number of bits of the data. For example, when the data is configured to have k bits, the respective sampling latches are set to have a size of k bits.

The holding latch unit 130 receives and stores the data from the sampling latch unit 120 when a source output enable (SOE) signal is input. Also, the holding latch unit 130 supplies the data stored therein to a DAC 250, when the source output enable (SOE) signal is input. Here, the holding latch unit 130 is provided with n holding latches for storing n data. Also, the respective holding latches have sizes corresponding to the number of bits of the data. For example, the respective holding latches are set to have a size of k bits for storing the data having k bits.

The DAC 140 generates an analog signal corresponding to the bit value of the input digital data, and the DAC 140 selects any one of a plurality of gray scale voltages (or gray levels) corresponding to the bit value of the data supplied from the holding latch unit 130, thereby generating the analog data signal.

The amplifier 150 amplifies the digital data converted into the analog signal to a certain or predetermined level and thus outputs it through data lines on a panel.

As such, the data driver of FIG. 1 outputs one data per one horizontal period. That is, after the data driver samples and holds one digital R, G, B data (or one set of R, G, B data) during one horizontal period, it converts them into analog R, G, B data and amplifies and outputs them at a certain or predetermined width. In addition, when the holding latch unit 130 holds the R, G, B data corresponding to n^{th} column line, the sampling latch unit 120 samples the R, G, B data corresponding to n+1^{th} column line.

FIG. 2 is a block diagram showing the DAC shown in FIG. 1.

Referring to FIG. 2, a conventional DAC 140 includes: a reference voltage generator 142, a level shifter 144, and a switch array 146.

As shown in FIG. 2, the DAC 140 uses a reference voltage generator 142 having R-strings R1, R2, . . . Rn for generating correct gray scale voltages and/or gamma-corrections, and includes a ROM type of a switch array 146 for selecting the voltages generated through the reference voltage generator 142.

The DAC 140 includes a level shifter for converting and providing a voltage level for digital data input through the sampling latch unit (120 in FIG. 1) to the switch array 146.

The DAC 140 has a disadvantage because power consumption is increased due to a static current of the R-strings. In order to overcome this disadvantage, an approach has been developed in which the R-strings are designed with large resistance values for reducing the static current flowing into the R-strings, and in which the desired gray scale voltages are applied to the respective data lines by using an analog buffer in the respective channels as the amplifier 150. However, this approach has a disadvantage because image quality is deteriorated due to the output voltage difference between channels, when threshold voltages and mobility of certain transistors constituting portions of the analog buffer are not uniform.

Also, in implementing a gray scale of 6 bits, 6★64 switches for selecting one of 64 gray scale voltages (or gray levels) should be built in the respective channels, causing a disadvantage in that circuit area is greatly increased. In an embodiment of the prior art, the area of a DAC implementing the gray scale of 6 bits occupies more than half of the area of a data driver.

As the bits of a gray scale (or the number of gray levels) are increased, even more circuit area may be needed. For example, in implementing a gray scale of 8 bits, the circuit area of a data driver can be increased to more than for times the circuit area of the DAC implementing the gray scale of 6 bits.

Also, recently, a flat panel display device using a system on panel (SOP) process that uses polycrystalline silicon TFTs to integrate driver(s), etc., along with a display region on a substrate has been developed. The above described disadvantages of the conventional DAC, i.e., the problems of power consumption and/or area usage, and the problem of implementing the analog buffer as the amplifier, become even more pronounced, when the flat panel display device is implemented using the SOP process.

### SUMMARY OF THE INVENTION

An aspect of the present invention provides a data driver and a driving method thereof, wherein when generating gray scale voltages corresponding to digital data input through charge sharing between at least two data lines of a plurality of data lines provided on a panel of a flat panel display device, the data driver presets the range of the gray scale voltages through upper k bits including a most significant bit (MSB) of the digital data and executes the charge sharing within the preset range, thereby minimizing power consumption and optimizing circuit area.

According to a first embodiment of the present invention, there is provided a data driver including: a shift register unit for providing sampling signals by generating at least one shift register clock; a sampling latch unit for sampling and latching digital data having m bits by receiving the sampling signals for every column line; a holding latch unit for simultaneously receiving and latching the digital data latched from the sampling latch unit, for outputting upper k bits including a most significant bit (MSB) of the digital data, and converting and outputting the remaining lower m-k bits of the digital data in a serial state, wherein k is less than m; and a digital-analog converter for presetting a range of gray scale voltages through the upper k bits of the digital data provided from the holding latch unit, for executing charge sharing to correspond to the remaining lower m-k bits, and for finally generating and outputting the gray scale voltages.

According to a second embodiment of the present invention, there is provided a flat panel display device including: a display region comprising a plurality of pixels connected to a plurality of scan lines arranged in a first direction and a plurality of data lines arranged in a second direction; a data driver supplying analog gray scale voltages to the plurality of pixels; and a scan driver supplying scan signals to the scan lines, wherein the data driver presets a range of the gray scale voltages through upper bits including a most significant bit (MSB) of digital data, and generates the analog gray scale voltages corresponding to the digital data through charge sharing between at least two of the data lines within the preset range and provides the analog gray scale voltages to corresponding ones of the pixels.

According to the third embodiment of the present invention, there is provided a data driving method of a flat panel display device including: presetting a range of gray scale voltages through upper k bits of input digital data; generating last gray scale voltages through charge sharing to correspond to lower bits of the digital data within the preset range of the gray scale voltages; and applying final ones of the generated gray scale voltages to the corresponding pixels through data lines.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a block diagram showing a conventional data driver;

FIG. 2 is a block diagram showing the conventional DAC as shown in FIG. 1;

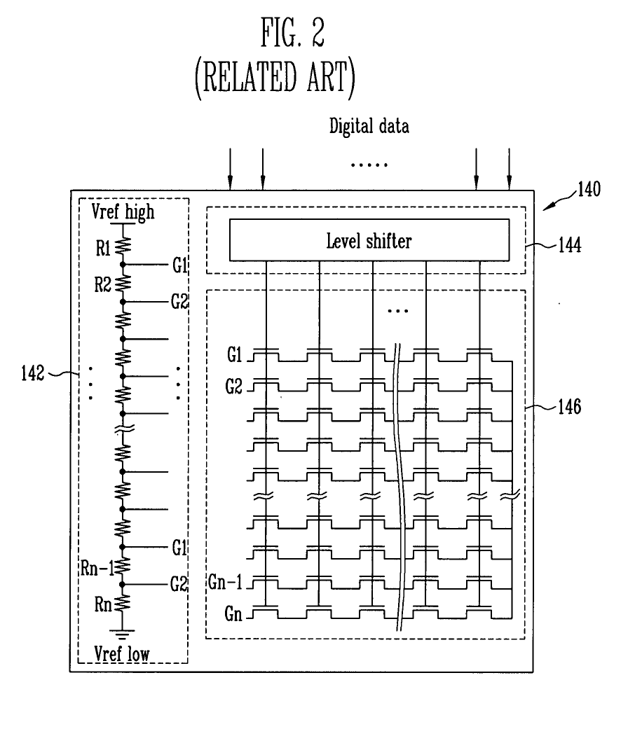

FIG. 3 is a block diagram showing a constitution of a data driver according to an embodiment of the present invention;

FIG. 4 is a block diagram showing a DAC of the data driver shown in FIG. 3;

FIG. 5 is a block diagram showing a gray scale generator of the DAC shown in FIG. 4;

FIG. 6 is a diagram showing a range of gray scale voltages set by a gray scale voltage range setting unit shown in FIG. 4;

FIG. 7 is a signal waveform diagram showing an example of a digital data input to the gray scale generator shown in FIG. 5;

FIG. 8 is a simulation waveform diagram showing outputs of the gray scale generator for the inputs shown in FIG. 7; and

FIG. 9 is a block diagram showing a flat panel display device according to an embodiment of the present invention.

### DETAILED DESCRIPTION

In the following detailed description, only certain exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, and not restrictive.

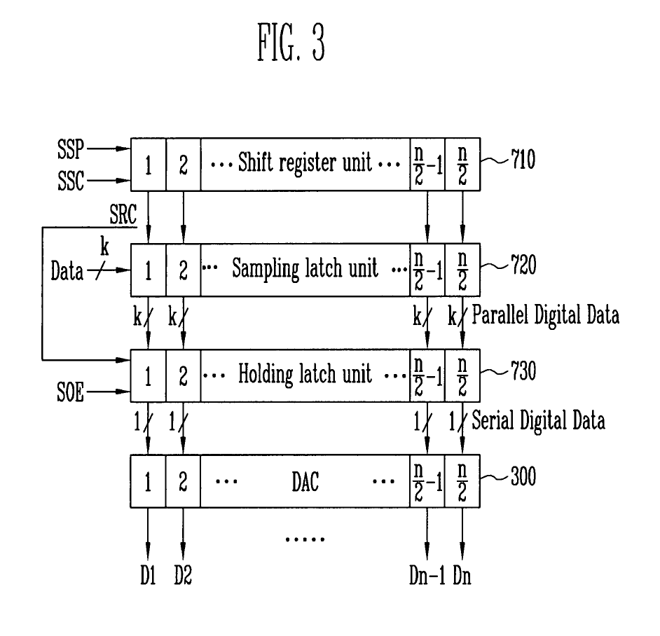

FIG. 3 is a block diagram showing a data driver according to an embodiment of the present invention.

For convenience purposes, the following description is directed to the data driver configured to receive digital data having 8 bits.

As shown in FIG. 3, the data driver includes a shift register unit 710, a sampling latch unit 720, a holding latch unit 730, and a digital-analog converter (DAC) 300.

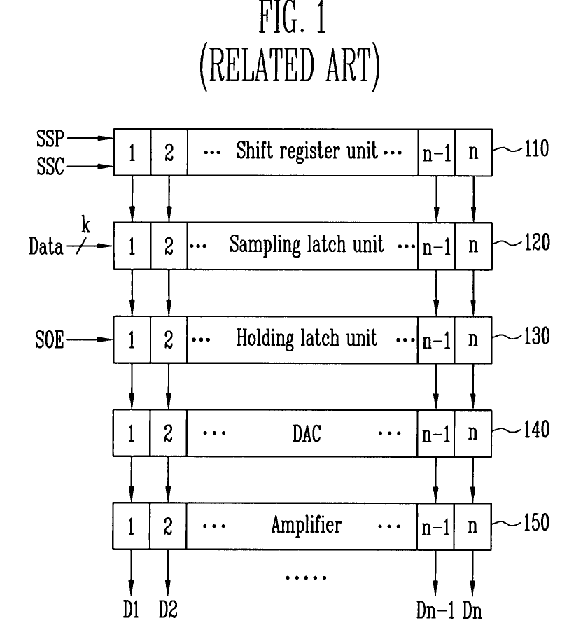

When comparing with the conventional data driver of FIG. 1, the data driver of FIG. 3 does not need to use an analog buffer as an amplifier, resulting in that the deterioration of image quality due to the difference of output voltages between channels caused by the analog buffer with non-uniformity (or unevenness) in threshold voltages and mobility can be overcome because the analog buffer does not have to be used as the amplifier.

Also, recently, a flat panel display device using a system on panel (SOP) process that uses polycrystalline silicon TFTs to integrate driver(s), etc., along with a display region on a substrate, has been developed. Therefore, the data driver according to the embodiment of the present invention is capable of overcoming the problems of power consumption and/or area usage, and also overcoming the problem of implementing analog buffer as the amplifier, even when these problems become even more pronounced, when the flat panel display device is implemented using the SOP process.

Further, when the DAC 300 provided in the data driver uses parasitic capacitance components existing in at least two data lines provided on a panel of the flat panel display device to generate gray scale voltages (or gray scale values or gray levels) corresponding to digital data input through charge sharing between the data lines, in particular, the DAC 300 provides a range of the gray scale voltages through upper k bits of the input digital data and executes the charge sharing within the range of the gray scale voltages, thereby minimizing power consumption and improving yield.

Referring to FIG. 3, the shift register unit 710 receives a source shift clock (SSC) and a source start pulse (SSP) from a timing controller (not shown), and generates a shift register clock (SRC) as n or n/2 sampling signals in sequence, while allowing the source start pulse (SSP) to be shifted for every one period of the source shift clocks (SSC). Here, the shift register 210 includes n or n/2 shift registers.

That is, the shift register unit 710 includes at least n/2shift registers, corresponding to n channels when the panel is driven using a 1:2 demuxing method.

The sampling latch unit 720 sequentially stores the data to be input in response to the sampling signals supplied from the shift register 710 in sequence. Here, the sampling latch unit 720 is provided with n or n/2 sampling latches for storing n digital data.

Also, the respective sampling latches have sizes corresponding to the number of bits of the data. For example, when the data is configured of 8 bits, the respective sampling latches are set to the size of 8 bits.

That is, the sampling latch unit 720 sequentially stores the input data and then outputs the 8 bits of the digital data to the holding latch unit 730 in a parallel state.

The holding latch unit 730 receives and stores the data from the sampling latch unit 720 when a source output enable (SOE) signal is input. That is, the holding latch unit inputs and stores the 8 bits of the digital data provided in a parallel state.

The holding latch unit 730 supplies the data stored therein to the DAC 740, when the source output enable (SOE) signal is input. Here, the holding latch unit 730 is provided with n or n/2 holding latches for storing n data. Also, the respective holding latches have sizes corresponding to the number of bits of the data. For example, the respective holding latches are set to have the size of 8 bits for storing the 8 bits of the data.

When outputting a digital data stored in the holding latch unit 730 to DAC 300, the present invention first outputs the upper k bits including MSB of the digital data to the DAC 300 to preset the range of the gray scale voltages to be generated, and then converts and outputs the remaining lower bits to the DAC in a serial state.

That is, assuming that the input digital data has 8 bits, and the holding latch unit 730 first outputs the upper 2 bits to DAC 300, the DAC presets the range of the gray scale voltages to be generated through the information provided by the upper 2 bits of the digital data.

The remaining lower 6 bits other than the upper 2 bits of the digital data are converted into a serial state and input to the DAC 300, and the DAC 300 executes the charge sharing within the preset range of the gray scale voltages, thereby finally generating the gray scale voltages to be input to the corresponding pixels.

As shown, the holding latch unit 730 receives the shift register clock signal (SRC) generated from the shift register and converts the lower 6 bits of the digital data of 8 bits into a serial state through the clock signal and outputs them to the DAC 300.

The DAC 300 generates analog signals corresponding to the bit values of the input digital data, and selects any one of a plurality of the gray scale voltages corresponding to the bit values of the data supplied from the holding latch unit 730, thereby outputting the gray scale voltages to the respective data lines.

In the present invention, the DAC 300 uses the parasitic capacitance components existing in at least two data lines of a plurality of data lines provided on the panel of the flat panel display device as a sampling capacitor and a holding capacitor to generate the gray scale voltages corresponding to the digital data input through the charge sharing between the data lines, and the DAC 300 presets the range of the gray scale voltages through the upper k bits of the digital data and executes the charge sharing for the remaining lower bits within the preset range, thereby finally generating the gray scale voltages.

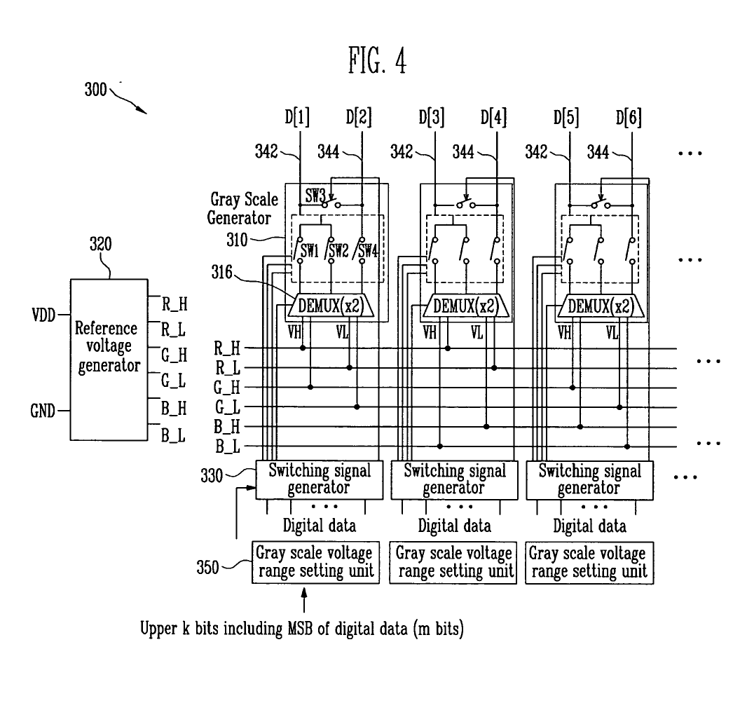

The DAC 300 according to the embodiment of the present invention will be described in more detail with reference to the following FIG. 4 to FIG. 9.

FIG. 4 is a block diagram showing the DAC 300 of FIG. 3 in more detail.

In one embodiment, the DAC 300 is provided in the data driver of the flat panel display device.

As described above, the DAC 300 uses parasitic capacitance components existing in at least two data lines of a plurality of data lines provided on the panel of the flat panel display device as the sampling capacitor and the holding capacitor to generate the analog gray scale voltages corresponding to the digital data (e.g., having a total of m bits) input through the charge sharing between the data lines, and the DAC 300 presets the range of the gray scale voltages through the upper k bits including MSB of the digital data and executes the charge sharing for the remaining lower bits (m-k bits) within the preset range, thereby finally generating the gray scale voltages.

Referring to FIG. 4, the DAC 300 includes: a gray scale generator 310 for executing the charge sharing (or sharing of charges) between first data lines 342 and second data lines 344, respectively; a switching signal generator 330 for providing operation control signals for a plurality of switches provided in the gray scale generator 310; a reference voltage generator 320 for generating reference voltages and providing them to the gray scale generator 310; and a gray scale voltage range setting unit 350 for setting the range of the gray scale voltages corresponding to digital data by receiving upper k bits (k<m) including MSB of the digital data (e.g., having a total of m bits).

Here, the reference voltage generator 320 generates respective high level and low level of reference voltages corresponding to the range of the gray scale voltages preset by the gray scale range setting unit for every red, green, and blue (R, G, B) data and provides them to the gray scale generator 310.

In one embodiment of the present invention, the data lines 342, 344, to which the certain or predetermined gray scale voltages are applied and provide the gray scale voltages to corresponding pixels connected to the data lines 342, 344. In additional, the data lines 342, 344 are used to provide the parasitic capacitance components existing in the data lines 342, 344 themselves.

The data lines 342, 344 can be modeled in the form of a plurality of resistors and capacitors that are connected, and therefore the capacitance values of the respective data lines can also be modeled or standardized with certain or predetermined values depending on the panel size, etc.

The embodiment of the present invention uses respective capacitance components existing in the first data lines 342 and the second data lines 344 formed adjacent to each other as the sampling capacitor and the holding capacitor, thereby generating the analog gray scale voltages corresponding to the digital data input through the charge sharing between first data lines 342 and second data lines 344 and providing the gray scale voltages to the corresponding pixels connected to the first or the second data lines 342, 344.

Here, as described with reference to FIG. 4, executing of the charge sharing between the two neighboring data lines is only one embodiment, and the present invention is not thereby limited. For example, instead of using the two neighboring data lines as the sampling capacitor and/or the holding capacitor, the present invention can also use the sum values of the respective parasitic capacitance components existing in two or more data lines as the sampling capacitor and/or the holding capacitor.

Also, instead of using the two neighboring data lines, the present invention can use the respective parasitic components existing in the at least two data lines receiving the same color of data, as the sampling capacitor and/or the holding capacitor.

However, in the embodiment shown in FIG. 3, since the parasitic capacitance components existing in the two neighboring data lines, that is, if the data lines receiving different colors are used, the gray scale generator 310 is provided with a demultiplexer 316 to differentiate the reference voltages for every data line. This is because the two neighboring data lines may receive the data corresponding to different colors; and the reference voltages may be different for every red, green, and blue (R, G, B) color.

In one embodiment, when using the respective parasitic capacitance components existing in the at least two data lines receiving the same color as the sampling capacitor and/or the holding capacitor, the demultiplexer 316 is not needed in the gray scale generator 310.

Also, the charge sharing does not necessarily have to be executed on all of the respective bits of the input digital data. For example, the upper k bits of the digital data are used for presetting the range of the gray scale voltages corresponding to the digital data, and thus if the range of the gray scale voltages is preset, each charge sharing is executed on the remaining lower bits (m-k bits) within the preset range, thereby finally selecting specific gray scale voltages within the preset range and outputting them to the corresponding pixels.

For example, assuming that the 8 bits of the digital data are input and the certain or predetermined range where the final gray scale voltage is set and generated through the upper 2 bits of the digital data, each charge sharing is executed on the remaining lower 6 bits of the digital data after setting the range, thereby determining specific gray scale voltages within the preset range.

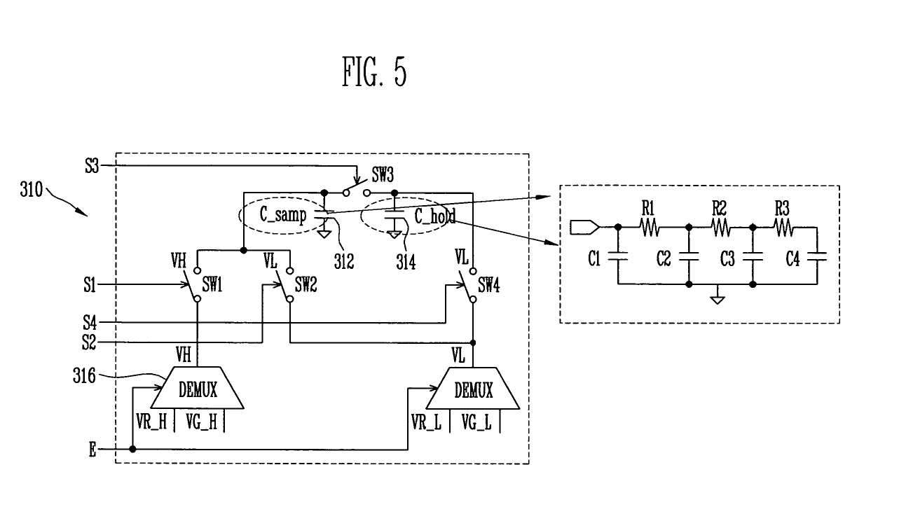

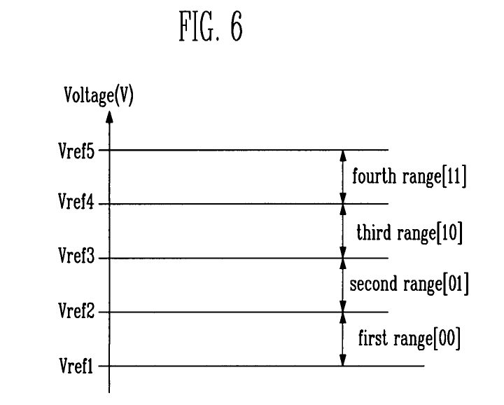

FIG. 5 is a block diagram showing the gray scale generator 310 in more detail, and FIG. 6 is a diagram showing the range of the gray scale voltages set by the gray scale voltage range setting unit 350.

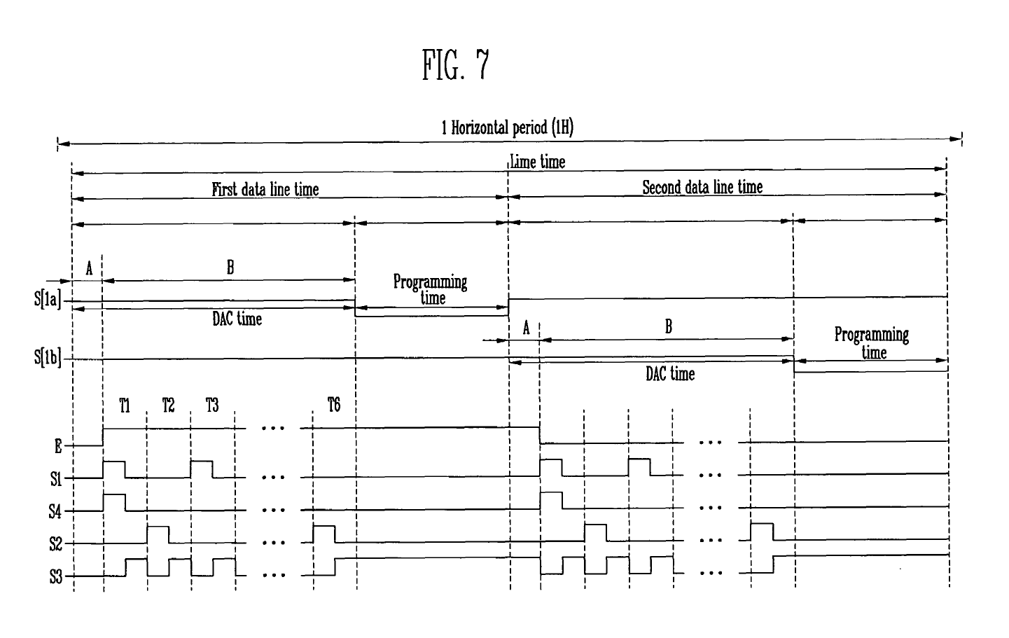

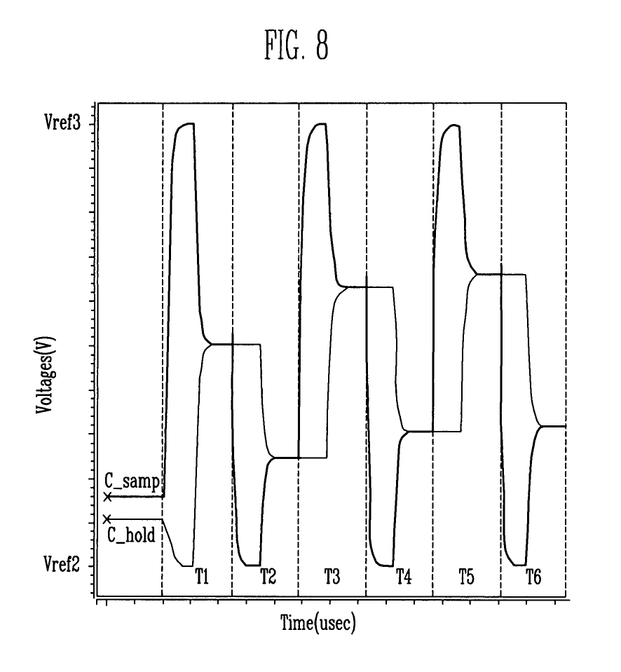

Also, FIG. 7 is a signal waveform diagram showing one example of digital data input to the gray scale generator 310 shown in FIG. 5, and FIG. 8 is a simulation waveform diagram showing outputs of the gray scale generator 310 for the inputs shown in FIG. 7.

In one embodiment of the present invention, since the gray scale voltages corresponding to one data line are generated by using the two neighboring data lines, the panel is driven using a 1:2 demuxing method, and thus the time that the respective data lines are driven is reduced to a half of an existing driving time (or a conventional driving time).

Also, for convenience of explanation, the embodiment of the present invention will be described on the assumption that the input digital data has 8 bits, and the upper 2 bits of the digital data is input to the gray scale voltage range setting unit 350.

Referring to FIG. 5, the gray scale generator 310 includes: a sampling capacitor C-samp 312 formed by parasitic capacitance components in one or more of the first data lines 342 in FIG. 4; a holding capacitor C-hold 314 formed by parasitic capacitance components in one or more of the second data lines 344 in FIG. 4; a first switch SW1 for controlling reference voltages at high levels (or high voltage levels) VH to be supplied to the sampling capacitor 312 depending on the respective bit values of the input digital data; a second switch SW2 for controlling reference voltages at low levels (or low voltage levels) VL to be supplied to the sampling capacitor 312 depending on the respective bit values of the input digital data; and a third switch SW3 provided for applying charge sharing between the sampling capacitor 312 and the holding capacitor 314.

The first data lines 342 and the second data lines 344 can be modeled by a plurality of resistors R1, R2, R3 and capacitors C1, C2, C3 that are connected as shown in FIG. 5, and therefore the capacitance values in the respective first data lines and second data lines can also be modeled or standardized with certain or predetermined values depending on the panel size, etc.

In the present invention, the respective parasitic capacitance components in the first and the second data lines are used as the sampling capacitor C_samp 312 and the holding capacitor C_hold 314.

Also, the gray scale voltage generator 310 is further provided with a fourth switch SW4 connected to the holding capacitor for initializing the holding capacitor C_hold 214.

Also, the embodiment of the present invention generates the gray scale voltages corresponding to one data line by using the two neighboring data lines, and drives the panel using the 1:2 demuxing method. Therefore, each data line transfers image signals corresponding to different colors of R, G, B and since the reference voltages corresponding to each color are different, the reference voltages must be differentiated for every data line to be provided to each data line.

Therefore, as shown, the gray scale generator 310 according to the embodiment of the present invention further includes a demultiplexer 316 for distinguishing and supplying reference voltage for each data line.

That is, the demultiplexer 316 does not supply the reference voltages corresponding to the second data lines when the certain or predetermined gray scale voltages are supplied to the first data lines, and does not supply the reference voltages corresponding to the first data lines when the certain or predetermined gray scale voltages are supplied to the second data lines.

In one embodiment, instead of using the two neighboring data lines, when using the respective parasitic components existing in the at least two data lines receiving the data of the same color as the sampling capacitor and/or the holding capacitor, the demultiplexer 316 is not needed in the gray scale generator 310.

Also, the signals S1, S2, S3, S4 and a signal E are provided from the switching signal generator 330 as shown in FIG. 3, and the high/low level of reference voltages are provided from the reference voltage generator 320. Here, the signal E is for controlling the operations of the first to fourth switches SW1 to SW4 and the demultiplexer 316.

When the gray scale generator 310 receives the 8 bits of the digital data, it executes the respective charge sharing for the remaining lower 6 bits after the upper 2 bits are input to the gray scale voltage range generator 350 to set the range of the gray scale voltage to be finally output therethrough, thereby executing the operation for generating specific gray scale voltage within the preset range.

That is, the DAC 300 presets the range of the gray scale voltage to be finally output by receiving the upper 2 bits of the 8 bits of the digital data through the gray scale voltage range setting unit 350, as shown in FIG. 6, and executes the charge sharing for the remaining lower 6 bits within the preset range through the gray scale generator 310, thereby finally generating the gray scale voltages.

Referring to FIG. 6, when the upper 2 bits of the input digital data are [11], the gray scale voltages are set to have a fourth voltage range that ranges from a voltage Vref4 to a voltage Vref5. When the upper 2 bits are [10], the gray scale voltages are set to have a third voltage range that ranges from a voltage Vref3 to the voltage Vref4. When the upper 2 bits are [01], the gray scale voltages are set to have a second voltage range that ranges from a voltage Vref2 to the voltage Vref3; and when the upper 2 bits are [00], the gray scale voltages are set to have a first voltage range that ranges from a voltage Vref1 to the voltage Vref2.

Hereinafter, as an example under the assumption that the input digital data [d7d6d5d4d3d2d1d0] are [1010101], an operation for generating the gray scale voltages corresponding to the digital data will be described in more detail below.

First, since the upper 2 bits of the digital are [01], the gray scale voltages of the digital data are set by the gray scale voltage range setting unit 350 to have specific voltages within the second voltage range that ranges from the voltage Vref2 to the voltage Vref3. Therefore, the gray scale voltage generator 310 executes each charge sharing by using the remaining lower 6 bits of the data within the second range, thereby finally generating the gray scale voltages.

A process executing the charge sharing will be described in more detail with reference to FIG. 7 and FIG. 8.

First, the sampling capacitor C_samp 312 is set to a high level VH or a low level VL of the reference voltage depending on the least significant bit (LSB) of the input digital data.

Here, the high level VH or the low level VL of the reference voltage corresponds to the gray scale voltage range preset by the gray scale voltage range setting unit 350.

Therefore, when the input digital data [d7d6d5d4d3d2d1d0] are [01010101], since the gray scale voltages correspond to the second voltage range that ranges from the voltage Vref2 to the voltage Vref3 by the setting of the upper 2 bits, the high level of the reference voltage becomes the voltage Vref3, and the low level of the reference voltage becomes the voltage Vref2.

That is, when the least significant bit (LSB) of the input digital data is 1 (LSB=1), the first switch SW1 is turned on to provide the high level of reference voltage Vref3 to the sampling capacitor 312, resulting in the sampling capacitor being set to the high level of reference voltage Vref3. Also, when the least significant bit (LSB) of the digital data is 0 (LSB=0), the second switch is turned on to provide the low level of reference voltage Vref2 to the sampling capacitor C_samp, resulting in the sampling capacitor C_samp being set to the low level of reference voltage Vref2.

Referring to FIG. 7 and FIG. 8, since the input digital data [d7d6d5d4d3d2d1d0] are [01010101], the LSB of the digital data is 1, resulting in the sampling capacitor C_samp being set to the high level of reference voltage Vref3. This is shown in a simulation graph of FIG.8.

Also, the holding capacitor C_hold is initialized simultaneously with inputting of the LSB of the sampling capacitor C_samp, wherein it is made by turning on the fourth switch SW4.

The embodiment of the present invention as shown in FIG. 4 represents that the holding capacitor C_hold is initialized as the low level of reference voltage Vref2. That is, by turning on the fourth switch SW4, the low level of reference voltage Vref2 is provided to the holding capacitor C_hold so that the holding capacitor C_hold is initialized with the low level of reference voltage. This is shown in a simulation graph of FIG. 6.

However, the above is only one embodiment, and the present invention is not thereby limited. For example, it is also possible to initialize the holding capacitor C_hold with the high level of reference voltage Vref3.

When assuming that the input digital data is 8 bits as shown in FIG. 7 and FIG. 8, for the remaining lower 6 bits other than the upper 2 bits used for generating the range of the gray scale voltage, the gray scale generator 310 executes the charge sharing between the sampling capacitor C_samp and the holding capacitor C_hold during the 6 periods where the respective bits are input, and the result that the 6^{th} (or final) charge sharing is finally executed to become the final gray scale voltages that are applied to the corresponding pixels through the data lines.

That is, for the input digital data, in the period T1 for receiving the first LSB and the respective periods T2, T3, T4, T5, and T6 for respectively receiving the next bits respectively from the second lower bit to the sixth bit, so that the first switch (when the bit value is 1) or the second switch (when the bit value is 0) is turned on depending on the respective bits to store the certain or predetermined reference voltages in the sampling capacitor C_samp, and the third switch SW3 is turned on for a period of each of the respective periods T2, T3, T4, T5, and T6 to apply the charge sharing between the reference voltages stored in the sampling capacitor C_samp and the voltages stored in the holding capacitor C_hold.

As a result, the certain or predetermined gray scale voltages corresponding to the digital data input through the charge sharing in the last sixth period T6 are generated and provided to the corresponding pixels through the data lines.

Referring to FIG. 4 to FIG. 8, a process generating analog gray scale voltages corresponding to the 8 bits of the digital data with [01010101] and applying them to the corresponding pixels connected to the data lines will be described in more detail below.

The DAC 300 according to the present invention sets the range of the gray scale voltages corresponding to the digital data through the upper 2 bits of the applied digital data and executes the charge sharing through the lower 6 bits of the digital data within the preset range, thereby generating the final gray scale voltage and applying the generated gray scale voltages to the corresponding pixels

When generating the gray scale voltages through the charge sharing between the first and the second data lines adjacent to each other as described above, the scan lines connected to each pixel need two scan lines S[na], S[nb] for every pixel, and the line time corresponding to the scan lines is thus reduced to a half of the conventional (or existing) line time.

That is, referring to FIG. 7, in case of the embodiment according to the present invention, the gray scale voltages corresponding to the pixels connected to the first scan line S[na] are generated, the gray scale voltages corresponding to the pixels connected to the second scan line S[nb] are generated, and the sum of the applied first data line time and the applied second data line time becomes the existing line time. Here, the line time corresponds to the period within one horizontal period 1H.

Also, the time that the gray scale voltages corresponding to the input digital data for each data line time are generated becomes a DAC time, and the time that the generated gray scale voltages are applied to the corresponding pixels becomes a programming time.

Accordingly, as shown in FIG. 7, the scan signals provided to the respective scan lines are provided at a low level only during the programming time.

Also, the DAC time is divided into a period A where the range of gray scale voltages is generated and a period B where the charge sharing is executed, and the period B where the charge sharing is executed is again divided into periods as many as the remaining lower bits, because the charge sharing between the sampling capacitor and the holding capacitor is generated whenever each bit is input. In the case of the present embodiment of the present invention, since the 8 bits of the digital data are input and the upper 2 bits are used for generating the gray scale voltage range, the period where the charge sharing is executed is divided into six periods T1 to T6. Accordingly, in the first period T1, since the LSB of the input digital data [01010101] is 1, a first switch SW1 is turned on to store a high level of reference voltage Verf3 in the sampling capacitor C_samp, resulting in the sampling capacitor C_samp being set to the high level of reference voltage Verf3.

When input digital data [d7d6d5d4d3d2d1d0] are [01010101] as described above, since the gray scale voltages correspond to the second voltage range that ranges from the voltage Vref2 to the voltage Vref3 by the setting of the upper 2 bits, the high level of the reference voltage becomes the voltage Vref3 and the low level of the reference voltage becomes the voltage Vref2.

Also, the holding capacitor C_hold is provided with the low level of the reference voltage Vref2 by turning on the fourth switch SW4 and it is thus initialized as the low level of the reference voltage Vref2.

Therefore, in the certain or predetermined period of the first period T1, that is, in the period of the remaining first period after the first switch SW1 is turned on, the third switch SW3 is turned on so that the voltages stored in the sampling capacitor C_samp and the charges stored in the holding capacitor C_hold are distributed, thereby converting and storing the voltages corresponding to a middle level of the voltage stored in the respective sampling and holding capacitors.

Next, in the second period T2, since the second lower bit is 0, the second switch SW2 is turned on so that the low level of the reference voltage Vref2 is stored in the sampling capacitor and in the period of the second period T2, that is, in the period of the remaining second period after the second switch SW2 is turned on, the third switch SW3 is turned on so that the voltages stored in the sampling capacitor C_samp and the charges stored in the holding capacitor C_hold are distributed, thereby converting and storing the voltages corresponding to a middle level of the voltage stored in the respective sampling and holding capacitors.

Next, from the third period to the eighth period T3 to T8, depending on the bits input as in the second period, the first switch SW1 is turned on (when the bit is 1) or the second switch SW2 is turned on (when the bit is 0), resulting in the high level of reference voltage Vref3 or the low level of reference voltage Vref2 being stored in the sampling capacitor, respectively. Among the respective periods in the period after the first switch SW1 or the second switch SW2 is turned on, the third switch SW3 is turned on so that the reference voltages stored in the sampling capacitor C_samp and the charges stored in the holding capacitor C_hold are distributed, resulting in the voltages of a middle level being stored in the sampling and the holding capacitors.

As a result, in the last sixth period T6, the voltages distributed in the sampling and holding capacitors finally become the gray scale voltages corresponding to the input digital data, and such digital data is provided to the corresponding pixels through the data lines.

The digital-analog converter DAC 300 as described above uses the respective capacitance components existing in the neighboring data lines as the sampling capacitor C_samp and the holding capacitor C_hold to generate desired gray scale voltages through the charge sharing between the data lines, thereby greatly reducing power consumption over the existing R-string type of the conventional DAC, and also greatly reducing the DAC area over an existing (or conventional) DAC area by removing an R-string, a decoder, and a switch array in the existing (or conventional) DAC constitution.

Also, the switching signal generator 330 as shown in FIG. 3 functions to generate and provide signals S1, S2, S3, S4, E for controlling the operations of a plurality of switches and the demultiplexer provided in the gray scale generator 310, wherein the first and second switches SW1, SW2 are determined to be turned on or off depending on the bit values of the input digital data so that the control signals are generated by the lower 6 bits values of the digital data output in a serial state through the holding latch unit.

That is, when the digital data bit value is 1, the switching signal generator 330 generates the control signal S1 allowing the first switch SW1 to be turned on and provides it to the gray scale generator 310, and when the digital data bit value is 0, the switching signal generator 330 generates the control signal S2 allowing the second switch SW2 to be turned on and provides it to the gray scale generator 310.

Also, the fourth switch SW4 should be turned on when the holding capacitor is initialized, and the third switch SW3 should regularly be turned on for a certain or predetermined period of the respective line time, that is, for every period where the respective digital data bits are input. Therefore, since the control signals S3, S4 of the third and fourth switches SW3, SW4 are signals that are repeated for every respective data line time regardless of the input digital data, they can be separately generated from a timing controller and used.

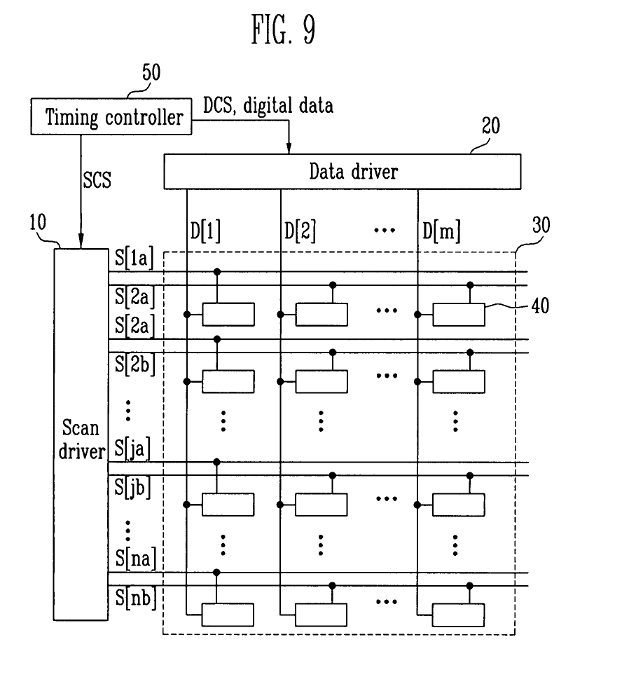

FIG. 9 is a block diagram showing a flat panel display device according to an embodiment of the present invention.

Here, since the flat panel display device includes a data driver described with reference to FIG. 3 to FIG. 8, the detailed description of the constitutions and the operations of the data driver will be provided again in more detail.

Referring to FIG. 9, the flat panel display device according to the embodiment of the present invention includes: a display region 30 including a plurality of pixels 40 connected to scan lines S[1] to S[n] and data lines D[1] to D[m]; a scan driver 10 for driving the scan lines S[1] to S[n]; a data driver 20 for driving the data lines D[1] to D[m]; and a timing controller 50 for controlling the scan driver 10 and the data driver 20.

The timing controller 50 generates a data driving control signal (DCS) and a scan driving control signal (SCS) in response to synchronizing signals supplied from one or more external sources. The data driving control signal (DCS) generated from the timing controller 50 is supplied to the data driver 20, and the scan driving control signal (SCS) is supplied to the scan driver 10. Also, the timing controller 50 supplies the digital data supplied from an external source to the data driver 20.

The data driver 20 receives the data driving control signal (DCS) from the timing controller 50. Therefore, the data driver 20 receiving the digital data and the data driving control signal (DCS) generates the gray scale voltages corresponding to the digital data and synchronizes the generated gray scale voltages with the scan signals to supply the corresponding gray scale voltages to corresponding pixels.

However, in one embodiment of the present invention, when using the parasitic capacitance components existing in the at least two data lines of the plurality of data lines provided on the panel of the flat panel display device as the sampling capacitor and the holding capacitor to generate the desired gray scale voltages through the charge sharing between the data lines, the embodiment presets the range of the gray scale voltages through the upper k bits of the digital data, and generates the analog gray scale voltages corresponding to the digital data input through the charge sharing within the preset range and provides them to the corresponding pixels.

The constitutions and the operations of the DAC 300 for generating the gray scale voltage and the data driver have been described above and the description thereof will therefore not be provided again.

However, in case of such a flat panel display device, as described above, the scan lines S[j] connected to each pixel need two scan lines S[na], S[nb] for every pixel, and the line time corresponding to the respective scan lines is reduced to a half of the existing (or conventional) line time.

In view of the foregoing, an embodiment of the present invention uses parasitic capacitance components existing in the at least two data lines as the holding capacitor and the sampling capacitor to generate the desired gray scale voltages through charge sharing between the data lines, thereby greatly reducing area and power consumption over an existing R-string type of DAC.

Also, an embodiment of the present invention uses the certain or predetermined upper bits of the input digital data to preset the range of the gray scale voltages, thereby reducing the process of charge sharing and optimizing power consumption and circuit area.

Also, an embodiment of the present invention can remove an R-string, a decoder and a switch array of the existing DAC constitution, thereby reducing the area of DAC over the existing R-string type of DAC.

Also, when manufacturing the data driver by using a SOP process, an embodiment of the present invention has an advantage that the deterioration of image quality due to a difference of output voltage between channels due to an analog buffer having variation in threshold voltages and mobility can be overcome because the analog buffer does not have to be used as an amplifier.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. A data driver comprising:
a shift register unit for providing sampling signals by generating at least one shift register clock;
a sampling latch unit for sampling and latching digital data having m bits by receiving the sampling signals for every column line;
a holding latch unit for simultaneously receiving and latching the digital data latched from the sampling latch unit, for outputting upper k bits including a most significant bit (MSB) of the digital data, and converting and outputting the remaining lower m-k bits of the digital data in a serial state, wherein k is less than m; and
a digital-analog converter for presetting a range of gray scale voltages through the upper k bits of the digital data provided from the holding latch unit, for executing charge sharing to correspond to the remaining lower m-k bits, and for finally generating and outputting the gray scale voltages.

2. The data driver as claimed in claim 1, wherein the digital-analog converter comprises:
a gray scale generator for executing the charge sharing between at least two data lines;
a switching signal generator for providing operation control signals for a plurality of switches provided in the gray scale generator;
a reference voltage generator for generating reference voltages and for providing the reference voltages to the gray scale generator; and
a gray scale voltage range setting unit for setting the range of the gray scale voltages corresponding to the upper k bits of the digital data including the MSB of the digital data.

3. The data driver as claimed in claim 2, wherein the charge sharing is executed by using respective parasitic capacitance components existing in the at least two data lines as a sampling capacitor and a holding capacitor.

4. The data driver as claimed in claim 2, wherein the reference voltage generator generates the reference voltages corresponding to the range of the gray scale voltages preset by the gray scale range setting unit and provides the reference voltages to the gray scale generator.

5. The data driver as claimed in claim 2, wherein the gray scale generator comprises:
a sampling capacitor formed by parasitic capacitance components in a first one of the data lines;
a holding capacitor formed by parasitic capacitance components in a second one of the data lines;
a first switch for controlling the reference voltages at high levels to be supplied to the sampling capacitor depending on bit values of the input digital data;
a second switch for controlling the reference voltages at low levels to be supplied to the sampling capacitor depending on the bit values of the input digital data;
a third switch provided for applying charge sharing between the sampling capacitor and the holding capacitor; and
a fourth switch connected to the holding capacitor for initializing the holding capacitor.

6. The data driver as claimed in claim 5, wherein the holding capacitor is initialized with any one of the reference voltages at the high levels and at the low levels by turning-on the fourth switch.

7. The data driver as claimed in claim 5, wherein the charge sharing is made between the sampling capacitor and the holding capacitor for m-k periods during which the lower m-k bits of the digital data are input, and wherein a result of the final charge sharing becomes final ones of the gray scale voltages applied to the corresponding pixels.

8. The data driver as claimed in claim 7, wherein the charge sharing evenly distributes the reference voltages stored in the sampling and holding capacitors by turning on the third switch

9. The data driver as claimed in claim 8, wherein the third switch is turned on after the first switch or the second switch has been turned on.

10. A flat panel display device comprising:
a display region comprising a plurality of pixels connected to a plurality of scan lines arranged in a first direction and a plurality of data lines arranged in a second direction;
a data driver supplying analog gray scale voltages to the plurality of pixels; and
a scan driver supplying scan signals to the scan lines,
wherein the data driver presets a range of the gray scale voltages through upper bits including a most significant bit (MSB) of digital data, and generates the analog gray scale voltages corresponding to the digital data through charge sharing between at least two of the data lines within the preset range and provides the analog gray scale voltages to corresponding ones of the pixels.

11. The flat panel display device as claimed in claim 10, wherein the charge sharing is executed by using respective parasitic capacitance components existing in the at least two of the data lines as a sampling capacitor and a holding capacitor.

12. The flat panel display device as claimed in claim 11, wherein the at least two of the data lines are a pair of data lines adjacent to each other.

13. The flat panel display device as claimed in claim 11, wherein the at least two of the data lines comprises more than two of the data lines for receiving data of the same color.

14. The flat panel display device as claimed in claim 11, wherein the parasitic capacitance components existing in the at least two of the data lines are sum values of the respective parasitic capacitance components existing in more than two of the data lines.

15. A data driving method of a flat panel display device comprising:
presetting a range of gray scale voltages through upper k bits of input digital data;
generating last gray scale voltages through charge sharing to correspond to lower bits of the digital data within the preset range of the gray scale voltages; and
applying final ones of the generated gray scale voltages to the corresponding pixels through data lines.

16. The data driving method of a flat panel display device as claimed in claim 15, wherein the charge sharing is made between the sampling capacitor and the holding capacitor for respective periods during which the lower bits of the digital data are input, and wherein a result of the final charge sharing becomes final ones of the gray scale voltages applied to the corresponding pixels

17. The data driving method of a flat panel display device as claimed in claim 16, wherein the sampling capacitor is implemented by parasitic capacitance components existing in a first one of the data lines, and the holding capacitor is implemented by capacitance components existing in a second one of the data lines.
